(19) United States
(12) Patent Application Publication
(10) Pub. No.: US 2024/0338622 A1
(43) Pub. Date: Oct. 10, 2024

(54) SYSTEMS AND METHODS FOR ALLOCATING DEVELOPMENT OF A DEVICE APPLICATION

(71) Applicant: Engineer.ai Corp., Salt Lake City, UT (US)

(72) Inventors: Sachin Dev Duggal, Salt Lake City, UT (US); Rohan Patel, London (GB)

(73) Assignee: Engineer.ai Corp., Salt Lake City, UT (US)

(21) Appl. No.: 18/295,844

(22) Filed: Apr. 5, 2023

(51) Int. Cl. G06Q 10/0631; G06F 8/10; G06Q 10/0639

(52) U.S. Cl. CPC G06Q 10/06313; G06F 8/10; G06Q 10/06398

(57) ABSTRACT

Systems, methods, and computer readable storage mediums for developing a device application are disclosed. An exemplary embodiment is a method for developing device applications. The method includes receiving a set of features of a 1^{st} device application and determining one or more subsets of the set of features where each subset is capable of operating independently of the other subsets in the 1^{st} device application area. The method further includes determining a production time for each subset. For each subset, the method includes tasking a developer to complete the subset at a time based on the production time.

### FIELD OF THE INVENTION

This disclosure relates to software automation, machine learning AI, and project management.

### BACKGROUND

It is expected that a hired individual, be they an employee or an independent contractor, is qualified for the job to which they are hired. However, verifying a hiree's qualifications may be challenging. For instance, employees may have embellished or exaggerated on their resumes. And employees who have accurate resumes may still have skills they have atrophied to the point that they are no longer competent to do the same work. Further, employee skills may change over time. For instance, employees gain experience and know-how as they work. On the other hand, some employees' work product may decline for various reasons such as burnout or life changes.

Even when the skill level of employees are known, it may be challenging to optimally use the employees' skills to best advantage. In the field of application development, it may be difficult to organize an optimum division of work based on project goals and employee skills.

There is a need in the art for a better way of ascertaining a level of skill for an employee when they are hired and during employment. There is a further need for a way of utilizing the employee based on their level of skill.

### SUMMARY

Systems, methods, and computer readable storage mediums for developing a device application are disclosed. An exemplary embodiment is a method for allocating resources to develop a software application. The method includes receiving one or more features for an undeveloped software application and determining one or more resource parameters for development of the undeveloped software application. The method further includes optimizing human development resources based on the one or more resource parameters and allocating human development resources based on the optimization. The one or more parameters may include a development expertise. The one or more parameters may further include an area of expertise. Allocating the human development resources may include determining a competence of one or more developers and assigning a subset of the one or more features to each of the one or more developers based on the competence being greater than or equal to the development expertise and the area of expertise. Allocating the human development resources may further include determining a production time for each subset of the one or more features where assigning the subset of the one or more features to each of the one or more developers is performed at a time that is optimized based on the production time for the subset. Receiving the one or more features may include resolving the one or more features from a machine readable specification. Allocating the human development resources may include contacting one or more developers by an automated computer system.

Another general aspect is a computer system that is configured to develop a device application. The computer system includes a processor coupled to a memory where the processor is configured to receive one or more features for an undeveloped software application and determine one or more resource parameters for development of the undeveloped software application. The processor is further configured to optimize human development resources based on the one or more resource parameters and allocate human development resources based on the optimization. The one or more parameters may include a development expertise. The one or more parameters may further include an area of expertise. The allocation of human development resources may include the processor configured to determine a competence of one or more developers and assign a subset of the one or more features to each of the one or more developers based on the competence being greater than or equal to the development expertise and the area of expertise. The allocation of human development resources may include the processor configured determine a production time for each subset of the one or more features where the processor is configured to assign the subset of the one or more features to each of the one or more developers at a time that is optimized based on the production time for the subset. The reception of the one or more features may include the processor being configured to resolve the one or more features from a machine readable specification.

An exemplary embodiment is a computer readable storage medium having data stored therein representing software executable by a computer. The software includes instructions that, when executed, cause the computer readable storage medium to perform receiving one or more features for an undeveloped software application and determining one or more resource parameters for development of the undeveloped software application. The instructions further cause the computer readable storage medium to perform optimizing human development resources based on the one or more resource parameters and allocating human development resources based on the optimization. The one or more parameters may include a development expertise. The one or more parameters may further include an area of expertise. Allocating the human development resources may include determining a competence of one or more developers and assigning a subset of the one or more features to each of the one or more developers based on the competence being greater than or equal to the development expertise and the area of expertise. Allocating the human development resources may further include determining a production time for each subset of the one or more features where assigning the subset of the one or more features to each of the one or more developers is performed at a time that is optimized based on the production time for the subset. Allocating the human development resources may include contacting one or more developers by an automated computer system.

Another general aspect is a method for developing components for a device application. The method includes determining one or more subprojects where each of the one or more subprojects include a development of one or more components applicable to a device application and determining a timing to develop the one or more subprojects. The method further includes determining an expertise to develop the one or more subprojects. For each of the one or more subprojects, the method further includes assigning one or more developers to develop the subproject and contacting each of the one or more developers to develop the subproject based on the timing. The method further includes determining a competence of each of the one or more developers prior to determining the one or more developers where the competence of each developer is greater or equal to the expertise for the subproject to which they were assigned. Determining a competence for each developer may include determining a score for the developer based on a job that was assigned to the developer where determining comprises evaluating the job automatically with a computer system. Determining one or more subprojects may include resolving the subprojects from a machine readable specification. The method may further include determining a production time for each of the one or more subprojects based on the expertise where assigning the one or more developers is based on the production time. The assigning may be optimized to complete a first development application, which incorporates at least one of the one or more components, based on time. The assigning may be further optimized to complete a second development application, which incorporates at least one of the one or more components, based on time.

An exemplary embodiment is a computer system configured to develop a device application. The computer system includes a processor coupled to a memory. The processor is configured to determine one or more subprojects, each of the one or more subprojects includes a development of one or more components applicable to a device application and determining a timing to develop the one or more subprojects. The processor is further configured to determine an expertise to develop the one or more subprojects. For each of the one or more subprojects, the processor is further configured to perform an assignment of one or more developers to develop the subproject and contact each of the one or more developers to develop the subproject based on the timing. The processor may be further configured to determine a competence of each of the one or more developers prior to determining the one or more developers where the competence of each developer is greater or equal to the expertise to for the subproject to which they were assigned. Determining the competence for each developer may include a processor configured to determine a score for the developer based on a job that was assigned to the developer and evaluate the job automatically with the computer system. Determining the one or more subprojects may include the processor being configured to resolve the subprojects from a machine readable specification. The processor may be further configured to determine a production time for each of the one or more subprojects based on the expertise where the processor is configured to perform the assignment of the one or more developers based on the production time. The assignment may be optimized to complete a first development application, which incorporates at least one of the one or more components, based on time. The assignment may be further optimized to complete a second development application, which incorporates at least one of the one or more components, based on time.

Another general aspect is a computer readable storage medium having data stored therein representing software executable by a computer. The software includes instructions that, when executed, cause the computer readable storage medium to perform determining one or more subprojects where each of the one or more subprojects include a development of one or more components applicable to a device application and determining a timing to develop the one or more subprojects. The instructions further cause the computer readable storage medium to perform determining an expertise to develop the one or more subprojects. For each of the one or more subprojects, the instructions further cause the computer readable storage medium to perform assigning one or more developers to develop the subproject and contacting each of the one or more developers to develop the subproject based on the timing. The instructions may further cause the computer readable storage medium to perform determining a competence of each of the one or more developers prior to determining the one or more developers where the competence of each developer is greater or equal to the expertise for the subproject to which they were assigned. Determining the competence for each developer may include determining a score for the developer based on a job that was assigned to the developers where determining includes evaluating the job automatically. Determining one or more subprojects may include resolving the subprojects from a machine readable specification. The instructions may further cause the computer readable storage medium to perform determining a production time for each of the one or more subprojects based on the expertise where assigning the one or more developers is based on the production time. The assigning may be optimized to complete a 1^{st} development application, which incorporates at least one of the one or more components, based on time.

An exemplary embodiment is a method for developing device applications. The method includes receiving a set of features of a 1^{st} device application and determining one or more subsets of the set of features where each subset is capable of operating independently of the other subsets in the 1^{st} device application area. The method further includes determining a production time for each subset. For each subset, the method includes tasking a developer to complete the subset at a time based on the production time. The method may further include determining internal dependencies for each subset where the production time is determined based on the internal dependencies. The method may further include determining a difficulty of developing each feature of the set of features where tasking the developer includes correlating and expertise of the developer to the difficulty. The expertise of the developer may be determined by an automated valuation where the automated evaluation includes determining a score for the developer and assigning to the developer a job based on a machine readable specification. The machine readable specification may include one or more jobs are completable by the developer. The automated evaluation may further include receiving a completed job based on one of the one or more jobs and updating the score based on an assessment of the completed job. The score may be a classification that corresponds to a classification of the job. The method may further include determining the classification of the job based on the machine readable specification. Tasking the developer may include automatically contacting, by a computer system, the developer to communicate a job to complete the subset.

Another general aspect is a computer system configured to develop a device application. The computer system includes a processor coupled to a memory where the processor is configured to receive a set of features of a 1^{st} device application and determine one or more subsets of the set of features where each subset is capable of operating independently of the other subsets in the 1^{st} device application. The processor is further configured to determine a production time for each subset. For each subset, the processor is further configured to task a developer to complete the subset at a time based on the production time. The processor may be further configured to determine internal dependencies for each subset where the production time is determined based on the internal dependencies. The processor may be further configured to determine a difficulty of developing each feature of the set of features where tasking a developer comprises the processor configured to correlate and expertise of the developer to the difficulty. The expertise of the developer may be determined by an automated evaluation where the automated evaluation includes a processor being further configured to determine a score for the developer and assign, to developers, a job based on a machine-readable specification. The machine readable specification may include one or more jobs that are completable by the developer. The automated evaluation may further include receiving a completed job based on one of the one or more jobs and updating the score based on an assessment of the completed job. The score may be a classification that corresponds to a classification of the job. The processor may be further configured to determine the classification of the job based on machine-readable specification. Tasking the developer may include the process of being configured to automatically contact the developer to communicate a job to complete the subset.

An exemplary embodiment is a computer readable storage medium having data stored therein representing software executable by a computer. The software may include instructions that when executed, cause a computer readable storage medium to perform receiving a set of features of a 1^{st} device application and determining one or more subsets of the set of features. Each subset may be capable of operating independently of the other subsets in the 1^{st} device application. The instructions may further cause the computer readable storage medium to perform determining a production time for each subset. For each subset, the instructions may further cause the computer readable storage medium to task a developer to complete the subset at a time based on the production time. The instructions may further cause the computer readable storage medium to perform determining internal dependencies for each subset where the production time is determined based on the internal dependencies. The instructions may further cause the computer readable storage medium to perform determining a difficulty of developing each feature of the set of features where tasking the developer includes correlating an expertise of the developer to the difficulty. The instructions may further cause the computer readable storage medium to perform determining a score for the developer, assigning to the developer, a job based on her machine-readable specification where this machine-readable specification comprises one or more jobs that are completable by the developer, receiving a completed job based on the one or more jobs, and updating the score based on an assessment of the completed job. The score may be a classification that corresponds to a classification of the job.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5A is a schematic of an embodiment of the disclosed system for evaluating a developer.

FIG. 5B is a schematic of an embodiment of the expert evaluation system.

FIGS. 6A-6B are a flow diagram of an embodiment of the disclosed system for allocating resources to develop a device application.

FIG. 7 is a flow diagram of an embodiment of the disclosed subject matter.

FIG. 8 is a flow diagram of another embodiment of the disclosed subject matter.

FIG. 9 is a flow diagram of yet another embodiment of the disclosed subject matter.

FIG. 10 is a flow diagram of an embodiment of a system for allocating developers to a job.

FIG. 11 is a flow diagram of an embodiment for allocating developers based on a machine readable specification.

FIGS. 12A-12B are schematics of embodiments for assessing effort required for a feature.

FIG. 13 is a schematic of an exemplary embodiment for allocating resources to a job.

FIG. 14 is another schematic of an exemplary embodiment for allocating resources to a job.

FIG. 15 is a schematic illustrating the computing components that may be used to implement various features of embodiments described in the disclosed subject matter.

### DETAILED DESCRIPTION

The disclosed subject matter is a system, method, and computer readable storage medium for allocating developer resources to development of a device application. The term device application, as used herein, refers to an application that runs on an electronic device. Examples of electronic devices that may run device applications include, but are not limited to mobile phones, desktop computers, laptop computers, television sets, IoT devices, console devices such as Xbox, airline media systems, and car media players. Individuals that may work on a device application include, but are not limited to developers of code that is configured to run a device application, designers of various aspects of the device application such as a user interface, and quality engineers who test functionality of a device application. As used herein, the term developer may refer to all such individuals.

In an exemplary embodiment, the disclosed subject matter allocates one or more developer resources to one or more jobs associated with development of a device application. For example, a device application may require development of a feature to include a relational database. The disclosed subject matter may allocate an optimum developer to complete the feature. In various embodiments, the disclosed subject matter may allocate multiple developers to work on different portions of a device application. For example, the disclosed subject matter may allocate a designer to generate designs for a device application. Further, the disclosed subject matter may allocate one or more developers to develop a first series of components for the device application. The disclosed subject matter may further allocate one or more other developers to develop a second series of components for the device application. The disclosed subject matter may resolve the first series of components from the second series of components based on the two series of components being capable of operating independently of one another. Thus the two series of components may be completed and tested in any order.

In an exemplary embodiment, the disclosed resource allocating system determines a time to allocate jobs to developers. For example, an evaluation system may determine a score for the developer which may indicate a speed at which the developer will likely complete a job. Accordingly, the system may allocate the job to the developer based on the speed at which the developer works in order to complete the job by a specific time.

The disclosed system may allocate developers to develop features for more than one device application where some of the features may be used by at least two device applications. For example, if a first feature is required for two separate device applications, the disclosed system may allocate a job to develop the feature once and share the feature between the two device applications.

In various embodiments, the disclosed system may test developers to determine an expertise of the developer prior to allocating jobs to the developer. The expertise of the developer may include an area of expertise. Areas of expertise for device application development include but are not limited to backend development, front-end development, mobile app security, user interface design, cross-platform development, mobile application testing, and mobile application deployment. Developers may be classified or ranked for each area of expertise.

This goes subject matter may include a system that reads the machine-readable specification to resolve one or more jobs and determine a difficulty of the one or more jobs. The system may further allocate the resolved jobs to developers based on the difficulty of the jobs and the expertise of the developers. The system may time the allocation based on a speed at which the developer works, a time at which a job needs to be completed, and any dependencies associated with the job. For example, a first feature may be dependent on the second feature. In one instance a backend of a device application may be dependent on the front-end. Thus, the front-end would need to be completed before the backend. Accordingly, the disclosed system would time the allocation such that the front-end is completed before development of the backend begins.

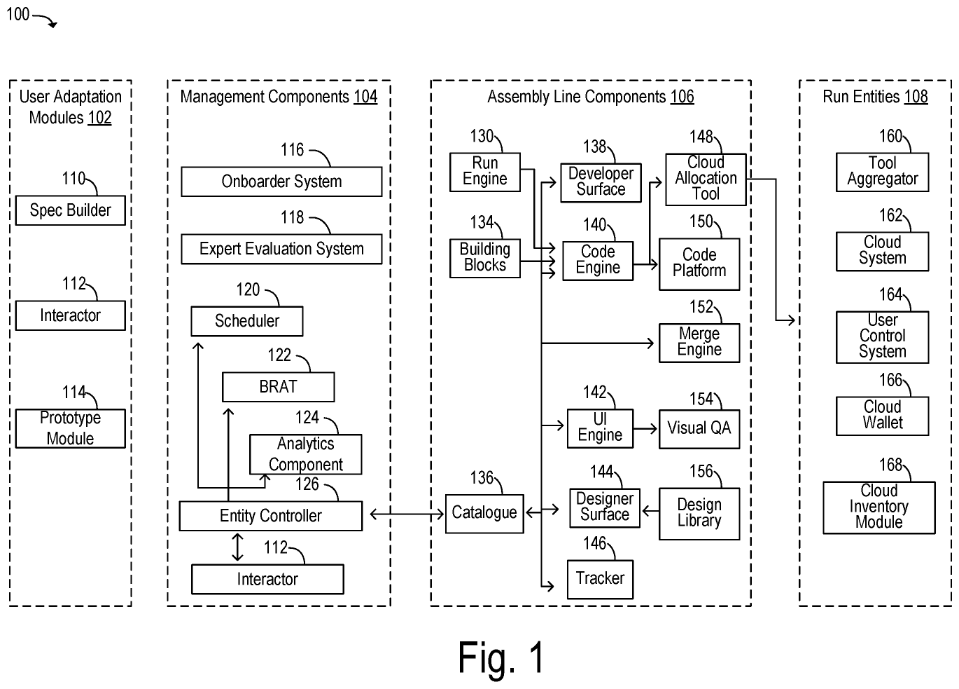

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

Spec builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

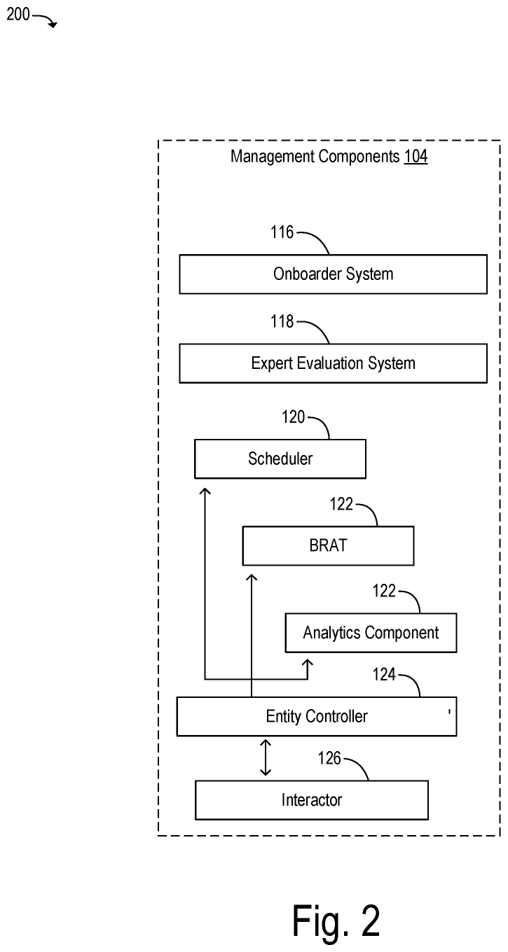

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

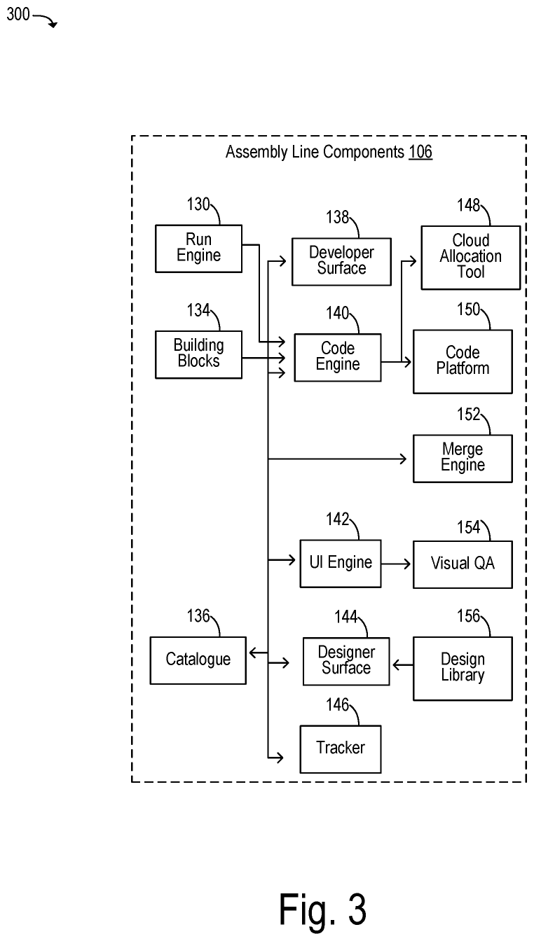

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

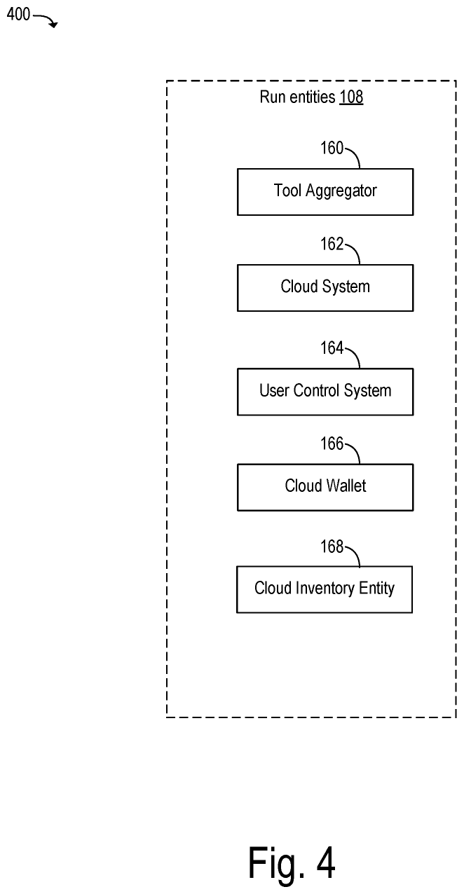

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

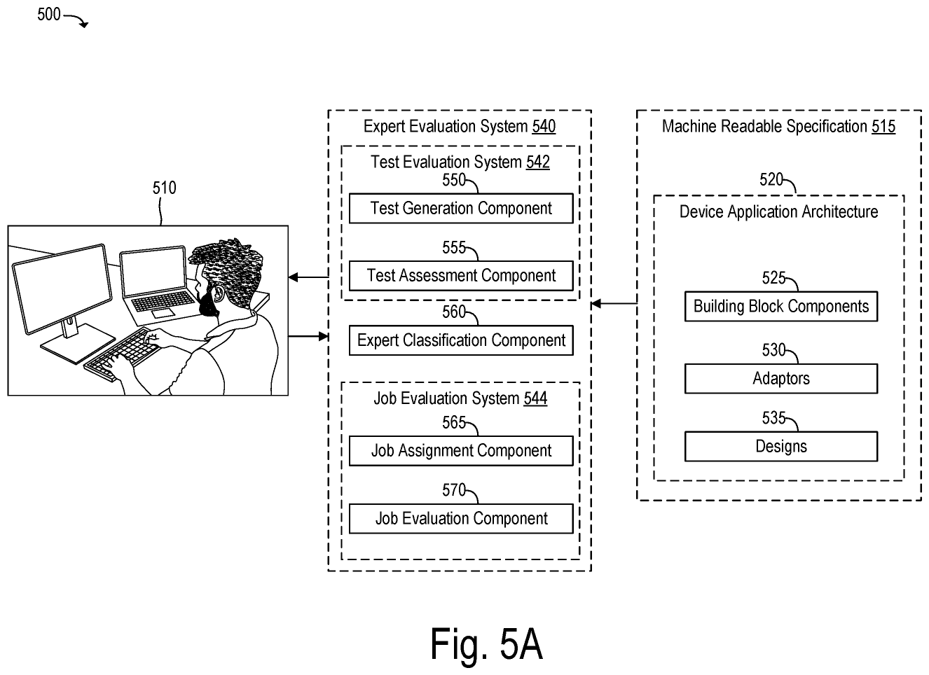

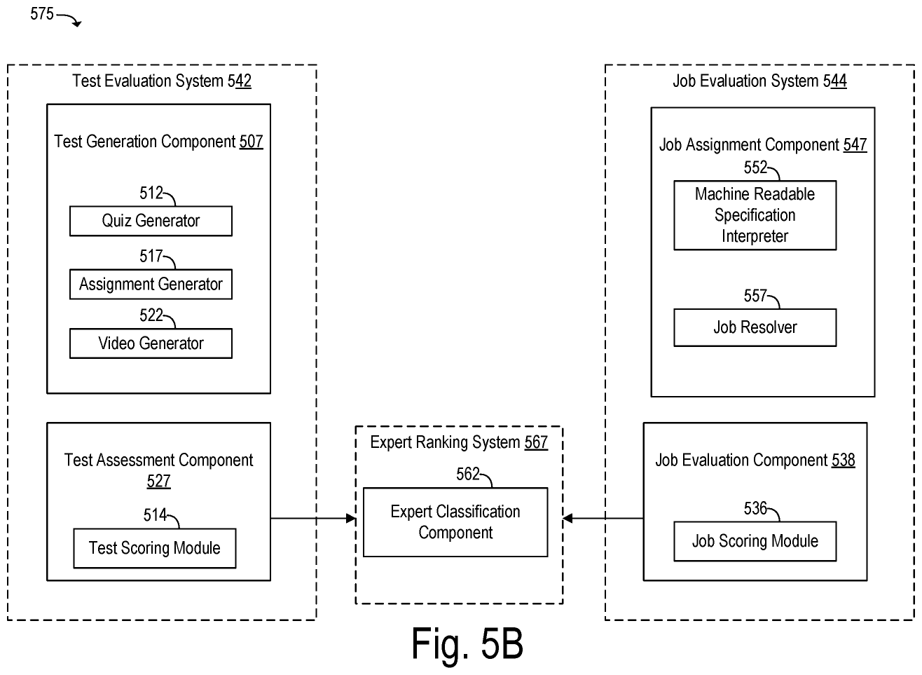

Referring to FIG. 5, FIG. 5 is a schematic 500 of an embodiment of the disclosed system for evaluating a developer 510. The developer 510 may be any individual that contributes to the development of a device application. The developer 510 may be a software developer, a designer, a quality engineer, or the like. The disclosed system may be used to classify one or more developers that are working on a device application. The classification may be used to assess the quality of work that employees are capable of performing. In various embodiments, the classification may be further used to match employees or developers to jobs that they are capable of performing.

In various embodiments, the disclosed subject matter may include a machine readable specification 515 for a device application. The machine-readable specification 515 may include information necessary to define one or more jobs that can be performed by the developer to contribute to the device application. For instance, the machine-readable specification 515 may include details necessary to build a building block component for the device application.

The disclosed system may include an expert evaluation system 540 that is capable of evaluating a developer 510 and evaluating jobs completed by the developer 510. In the exemplary embodiment shown in the schematic 500, the expert evaluation system 540 includes a test evaluation system 542, an expert classification component 560, and a job evaluation system 544.

The test evaluation system 542 may be used to test a developer 510 to determine the developer's 510 ability level. For instance, the test evaluation system 542 may give the developer 510 one or more tests for the developer to complete. Once completed, the test evaluation system 542 may grade the one or more tests to classify the developer 510. The test evaluation system 542 may include a test generation component 550 and a test assessment component 555. The test generation component 550 may be configured to generate one or more tests for the developer 510. In an exemplary embodiment, the test generation component 550 may generate one or more quizzes based on a developer's experience. The developer's experience may be determined based on a resume, an interview with the developer, or the like. An example of a quiz may be a test comprising one or more questions for which there is at least one correct answer. In addition to quizzes, the test generation component 550 may generate one or more assignments for the developer. An example of an assignment may be a task to complete a building block component. Another example of an assignment may be a task to design a user interface for a screen. Another example of a task may be to quality test a device application. An assignment for a developer that is a quality engineer may include conducting an analysis of a device application to identify defects or bugs in the device application. Another assignment for a developer that is a quality engineer may include making one or more improvements to a functionality of a device application or portion of a device application.

The test evaluation system 542 may transmit one or more quizzes or assignments that are generated by the test generation component 550 to the developer 510 for the developer to complete. Once completed, the developer 510 may transmit the completed quiz or assignment back to the test evaluation system 542. The test assessment component 555 may evaluate the completed quiz or assignment to determine a score or rank for the developer 510. For example, the test assessment component 555 may determine whether the developer 510 answered questions in the one or more quizzes correctly. In addition to grading quizzes, the test assessment component 555 may also evaluate assignments that are completed by the developer 510. For example, the test assessment component 555 may evaluate a completed assignment for various criteria to determine a score for the completed assignment. For instance, the test assessment component 555 may use a machine learning algorithm to evaluate a quality of an assignment to develop a software component or device application. An example of a machine learning algorithm is a neural network. In the example given above, the machine learning algorithm may evaluate a structure of the completed assignment to determine whether the structure conforms to standard industry practice. For instance, the machine learning algorithm may evaluate whether the developer 510 adhered to an entity component pattern that was called for in the assignment. The machine learning algorithm may further evaluate output based on various input for the completed assignment. For instance, if the assignment was to develop a component that accepts one or more user logins and sorts them into a database, the machine learning algorithm may test the completed component with one or more user logins to determine whether the completed assignment works properly.

The test assessment component 555 may generate a score that may be used by an expert classification component 560 to determine a classification or rank of the developer 510. The expert classification component 560 may use any combination of quiz scores and assignment scores to determine a classification for the developer 510. In various embodiments, the expert classification component 560 may weight one or more quizzes or assignments based on various criteria. For instance, the expert classification component 560 may weight a quiz that is related to a developers 510 expertise more than other quizzes or assignments. In another example, the expert classification component 560 may weight one or more quizzes or one or more assignments based on jobs that are available from the machine-readable specification 515. For instance, the expert classification component 560 may weight quizzes or assignments related to databases if there are pending jobs that require database work. A pending job may be a job that is yet to be completed. The term “pending machine readable specification”, as used herein, is a machine readable specification that includes one or more pending jobs.

The job evaluation system 544 transmits jobs to the developer 510 and assesses completed jobs that are received from the developer 510. In an exemplary embodiment, the job evaluation system 544 may include a job assignment component 565 and a job evaluation component 570. The job assignment component 565 may accept one or more jobs based on a machine-readable specification 515. In an exemplary embodiment, the machine-readable specification 515 may include one or more building block components 525, one or more adapters 530 that are designed to link the building block components 525, and one or more designs 535 for a device application. Additionally, the machine-readable specification 515 may include a device application architecture 520 that defines a structure for the building block components 525, the adapters 530, and designs 535.

One or more jobs may be resolved from the machine-readable specification 515. The jobs may be then passed by the job assessment component 565 to a developer 510 to be completed. Once completed, the developer 510 may transmit the completed job back to the job evaluation system 544. The job evaluation component 570 may assess the quality of the completed job. In an exemplary embodiment, the job evaluation component 570 comprises a machine learning algorithm that is configured to evaluate completed jobs. In various embodiments, different machine learning algorithms or models may be configured based on a type of job. For example, a machine learning algorithm may be configured to evaluate completed user interface components for device applications. For instance, a job to develop a building block component 525 that allows a user to select one or more items for purchase on a device application may be assigned to a developer 510. Once the job is completed, the job evaluation component 570 may evaluate the completed job using a machine learned algorithm that is trained to evaluate components related to user input.

Referring to FIG. 5B, FIG. 5B is a schematic of an embodiment of the expert evaluation system 575. The expert evaluation system 575 may be used to score or classify developers that work on various aspects of a device application. In an exemplary embodiment that is shown in FIG. 5B, the expert evaluation system 575 includes a test evaluation system 542, an expert ranking system 567, and a job evaluation system 544. The test evaluation system 542 generates tests for developers 510 and grades tests once they are completed by developers 510. In an example embodiment, the test evaluation system 542 includes a test generation component 507 and a test assessment component 527.

The test generation component 507 generates quizzes, assignments, and/or videos for the developer 510. In an exemplary embodiment, the test generation component 507 may include a video generator 522 that generates videos for the developer 510 to view. The videos may be educational or part of the test. For example, the video generator 522 may generate one or more videos based on a content of quizzes or assignments that will be transmitted to the developer 510. For example, a video generator 522 may generate a video that includes a code structure tutorial for the developer 510 to view before working on an assignment. Accordingly, the developer 510 could be tasked to adhere to a structure based on the video as the developer 510 works on the assignment.

The quiz generator 512 may generate quizzes for developers 510. In an exemplary embodiment, quiz questions are selected based on the experience level of the developer 510. For example, if the developer's resume shows expert level experience in using cloud platforms, the quiz generator 512 may test the developer's 510 experience with questions related to cloud providers such as AWS and Azure. In another example, the quiz generator 512 may generate quiz questions based on pending jobs. For example, the quiz generator 512 may generate a ratio of quiz questions based on the ratio of job types that are pending. An example ratio of job types may comprise 30% of jobs related to SQL databases. Accordingly, the quiz generator 512 may generate questions related to SQL databases for approximately 30% of the questions on the quiz.

The assignment generator 517 may generate assignments for the developer 510 that can be graded by the test assessment component 527. The assignment generator 517 may be configured to generate assignments that are capable of being graded or scored. For instance, the assignment generator 517 may generate assignments directing a developer to produce a component that performs a specific function based on specific input. For example, the assignment generator, 517 may direct a developer 510 to produce a component that interacts with a bank API to perform a transaction. Accordingly, the test scoring module 514 of the test assessment component 527 may be capable of verifying a correct output of the component based on the bank API of the assignment. In various embodiments, the assignment generator 517 may be configured to assign a developer 510 assignments that are related to the developer's experience.

The test assessment component 527 may grade completed quizzes and completed assignments with the test scoring module 514 to determine a score for the developer 510. In various embodiments, the test scoring module 514 comprises a machine learning algorithm that is trained to grade quizzes and/or assignments. Various machine learning algorithms may be used for the test scoring model 514. In an exemplary embodiment, the machine learning algorithm is a neural network that uses natural language processing to analyze completed assignments and determine a quality of the completed assignment. Thus, completed quizzes and assignments may be assigned a score that is passed on to the expert ranking system 567. The expert ranking system 567 may pass scores through the expert classification component 562 to determine a rank or classification of the developer 510 based on scores determined by the test assessment component 527. In an exemplary embodiment, the expert classification component 562 classifies a developer 510 as one of either beginner, intermediate, or expert. In various embodiments, the expert classification component 562 determines a classification for each developer in multiple areas. For instance, a developer 510 may be classified as intermediate in relational databases and classified as a beginner in NoSQL databases.

The job evaluation system 544 assigns jobs to developers and evaluates completed jobs from developers 510. The job evaluation system 544 may include a job assignment component 547 and a job evaluation component 544. The job assignment component 547 may determine one or more jobs from a machine-readable specification to be assigned to a developer 510. The job evaluation component 547 may assess completed jobs to determine a score that is passed to the expert ranking system 567.

The job assessment component 547 may include a machine readable specification interpreter 552 and a job resolver 557. The machine-readable specification interpreter may be configured to extract all related information from machine-readable specifications. For instance, the machine-readable specification interpreter 552 may extract information related to one or more components, designs, and adapters. The job resolver 557 may determine one or more jobs based on the components, designs, and adapters specified in the machine-readable specification. In an exemplary embodiment, the job resolver 557 may resolve jobs based on links between components as defined by the machine-readable specification. In various embodiments, the machine-readable specification may define links between various features and components in the device application. The job resolver may select one or more components based on the links. In one example, the job resolver may resolve a job to develop two components that communicate with one another. An example of components that communicate with one another comprises a first component that generates a message that is transmitted through the run engine and received by a second component.

In various embodiments, the job resolver 557 may determine a difficulty of the job. For example, the job resolver 557 may comprise a machine learning algorithm that is configured to determine a difficulty of a job. The machine learning algorithm may be trained, for example, on difficulties of previous jobs. In one example, the difficulty may be determined based on an amount of work to be performed for a job. An amount of work may be correlated to a number of linkages between components for a job to complete a building block component. For example, a building block component that is linked to two or more other building block components may be classified as expert level difficulty. A building block component that is linked to one other building block component may be classified as an intermediate difficulty. And a building block component that has no links to other building block components may be classified as a beginner level difficulty.

Once a developer 510 completes a job, the completed job is passed to the job evaluation component 538. The job scoring module 536 may assign a score to the completed job based on a quality of the completed job. In an exemplary embodiment, the job scoring module may use a machine learning algorithm to analyze the completed job to determine the quality of the job. For example, the job scoring module may use a neural network that makes use of natural language processing to assess code that is submitted by the developer to develop a building block component for a device application. In another example, the job scoring module 536 may use a neural network to analyze a design for a user interface. For instance, the neural network may be trained to determine a score for various types of designs such as hero images, navigation menus, car layouts, and modal window designs. In one example, the neural network may be configured to evaluate a hero image based on an L-shaped pattern whereby interactive portions of the image are limited to two adjacent sides of the screen. The job scoring module 536 may output a score that may be evaluated by the expert ranking system 567 to determine a rank or update the rank/classification for the developer 510.

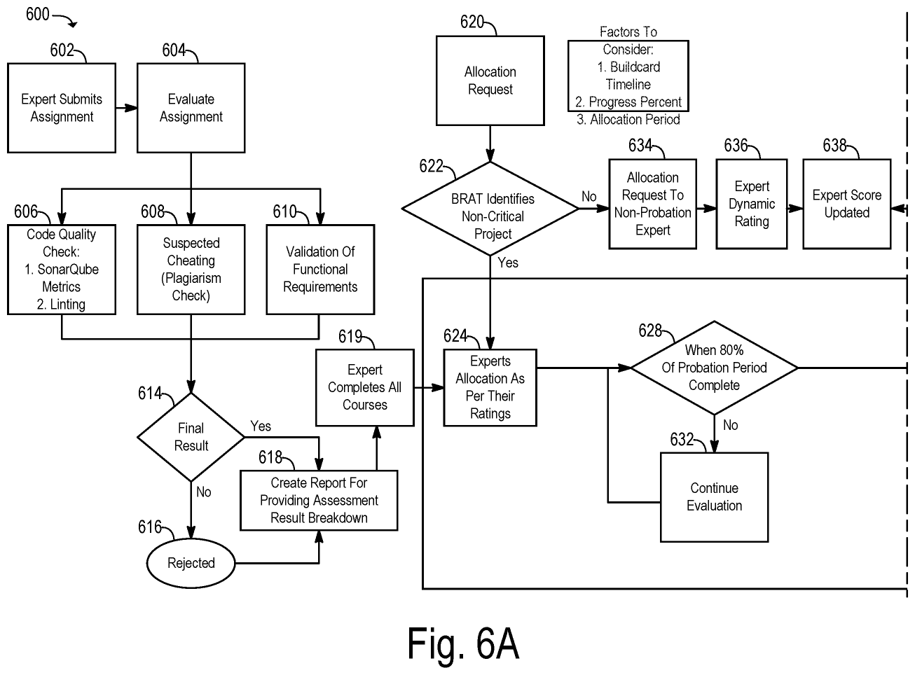

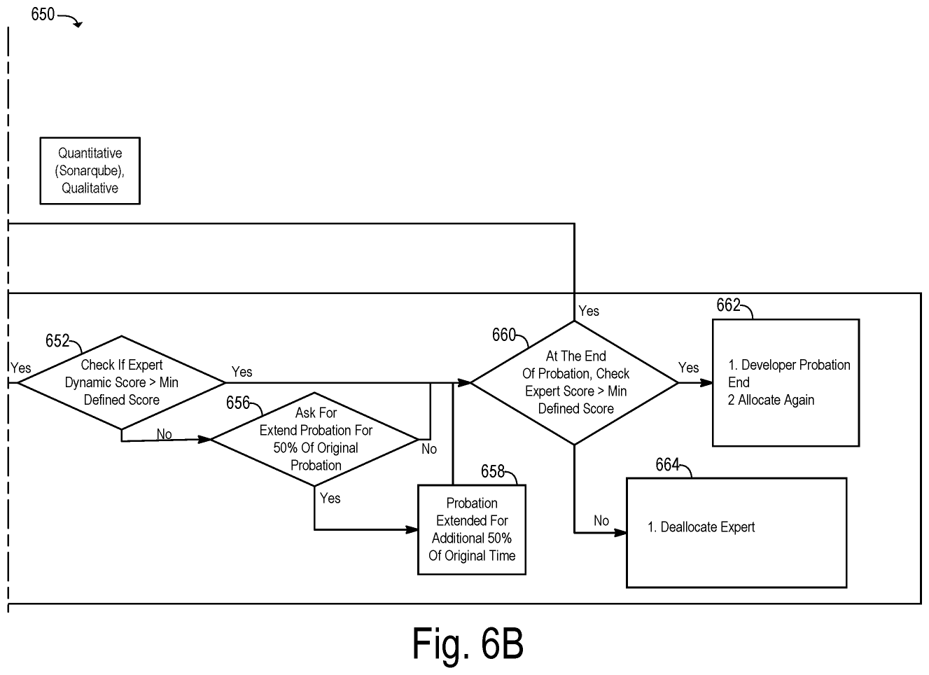

Referring to FIGS. 6A-6B, FIGS. 6A-6B together show portions of a single flow diagram of an embodiment of the disclosed system for allocating resources to develop a device application. FIG. 6A shows a first flow diagram 600 of a system for allocating resources. The system for allocating resources may select one or more developer resources to work on a job to contribute to generation of a device application. Various jobs may include, but are not limited to developing a building block component, designing an interface, and testing a quality of the device application. In various embodiments, the system for allocating resources may receive one or more jobs from the job resolver 557 and determine the optimal developer(s) to complete each job. The system for allocating resources may further automatically contact the developer and manage the timing at which jobs are completed.

At step 602, an expert submits an assignment to the system. In various embodiments, the assignment is received by the test evaluation system 542. At step 604, the test assessment component 527 may evaluate the assignment to determine a score for the assignment.

In the exemplary embodiment shown in FIG. 6A, the test assessment component 527 may perform a variety of checks on the assignment. The type of check may depend on the type of work that was performed for the job. For example, a job to develop a new component may be checked according to the steps shown in the first flow diagram 600. At step 606, the test assessment component 527 may check a quality of a development code. An exemplary embodiment the quality may be checked by analyzing SonarQube metrics and linting the code. Both the SonarQube metrics and linting are ways to check code for various errors and conforming to various standards. Further, at step 608, the test assessment component 527 may do a plagiarism check on the submitted code. And at step 610, the test assessment component 527 may validate the functional requirements of the code. The functional requirements may be verified by a machine learned algorithm that analyzes the completed assignment. At step 614, the test assessment component 527 may determine a final score for the assignment. If the score doesn't meet a minimum threshold, the assignment will be rejected at step 616. At step 618, the system may create a report providing a breakdown of the score. And at step 619, the system may determine whether the developer completed all courses and including tests and assignments. In various embodiments, a developer may be required to complete a minimum number of courses or assignments including quizzes, tests, or the like before being verified to work on a job. In an exemplary embodiment, developers that complete around of courses will be placed on probation whereby they are further evaluated based on completed job assignments.

At step 620, the system for allocating resources may receive an allocation request to complete one or more tasks related to generating a device application. At step 622, the big resource allocation tool may determine whether the allocation request is related to a noncritical project. A noncritical project may be any project that has a low priority. In an exemplary embodiment only projects that are noncritical are low priority. If the job is determined to be noncritical, a developer or expert that is on probation may be considered for the job. If the job is considered to be critical however, only non-probation developers are considered.

At step 634, the system for allocating resources may allocate a job based on the allocation request to a non-probation developer. The job may be determined by the job resolver 557 by interpreting a machine-readable specification. Once the developer completes the job, the job may be evaluated by the job evaluation component 547 at step 636. At step 638, the score determined by the job evaluation component 547 is updated.

At step 624, where it the system determined that an allocation request was noncritical, probationary and non-probationary developers may be considered. The classification or score of the developers may be considered to assign their job. In various embodiments developers that are on probation are assigned jobs that are one rank lower than their classification. For example, a developer that is on probation may be assigned jobs that have a difficulty that is below their level of classification. At step 628, a probationary period is tracked for the developer that if the developer is in a probationary period. An exemplary embodiment, the probationary period may be for an amount of time, a number of projects, or combination thereof. In the embodiment shown in the first flow diagram 600, developers that are within their probationary period are continually evaluated at step 632 until they reach 80% of their probation period.

Referring to FIG. 6B, FIG. 6B shows a second flow diagram 650 of a system for allocating resources. In the exemplary embodiment where the probationary developer has reached 80% of their probationary period and step 632, the system for allocating resources may check if their score meets a minimum threshold at step 652. The minimum threshold may be set to any arbitrary number that represents a minimum level of expertise required for the developer. If the developer does not meet the minimum threshold, the probation period may be extended for an amount of time. In the exemplary embodiment shown in the second flow diagram 650, the probationary period may be extended by 50% at step 658 based on a request at step 656.

At step 660, the system for allocating resources may determine whether the developer's score meets a minimum threshold. If the score does meet the minimum threshold, the developer's probation will end at step 662 and the developer's rating will be updated at step 638. If the developer does not meet the minimum threshold, the developer may be the deallocated and not considered for further jobs at step 664.

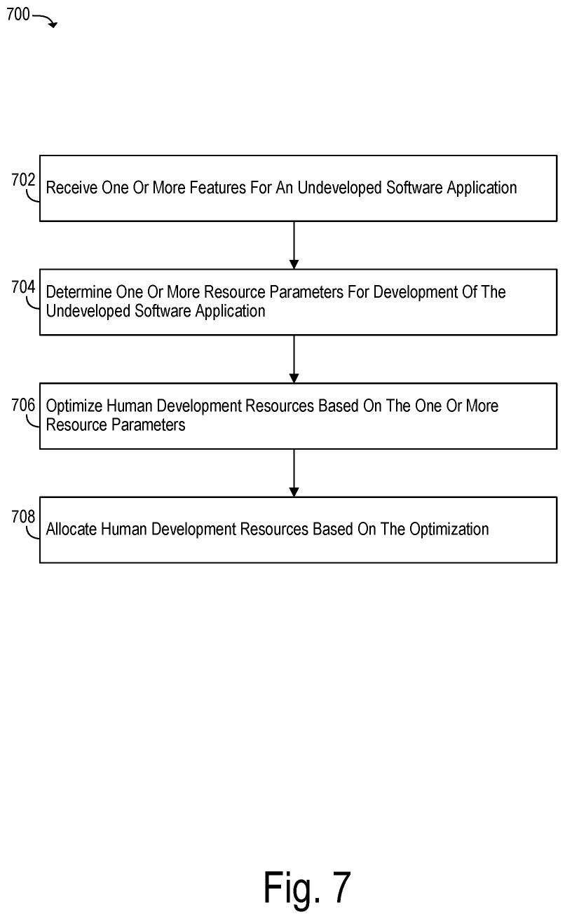

Referring to FIG. 7, FIG. 7 is a flow diagram 700 of an embodiment of the disclosed subject matter. The disclosed subject matter may be used to allocate human development resources to one or more jobs on a device application. In an exemplary embodiment, the job may be to work on an undeveloped software application. At step 702, the system to allocate resources may receive one or more features for an undeveloped software application. In various embodiments, the features may be supplied by a user or client. The system may be tasked by the user or client to incorporate the features into a device application. The features may be incorporated into a machine-readable specification whereby the job resolver 557 may resolve one or more jobs from the machine-readable specification.

At step 704, the system to allocate resources may determine one or more resource parameters for development of the undeveloped software application. Various parameters may include a development expertise needed for one or more jobs, an area of expertise, and a time needed for development of the undeveloped software application. As used herein, the term development expertise may refer to a total level of experience of a developer. The total level of experience may be in a specific area of expertise, a total experience, or combination thereof. For example, a developer may be classified as a level II developer for front-end systems and classified as a level I for backend systems. The developer may also be classified as a level II developer overall.

At step 706, the system to allocate resources may optimize human development resources based on the one or more resource parameters. For example the system may determine a best developer to develop the undeveloped software application based on the one or more resource parameters. In various embodiments, more than one developer may be determined to develop the undeveloped software application at step 706. In an exemplary embodiment, and optimization algorithm may be used to determine the one or more developers based on the one or more resource parameters.

At step 708, the system to allocate resources may allocate human development resources based on the optimization. For example, the system to allocate resources may contact the one or more developers that were selected at step 706. In various embodiments, the system may further assign the one or more developers specific jobs to develop though undeveloped software application based on jobs that were determined by the job resolver 557.

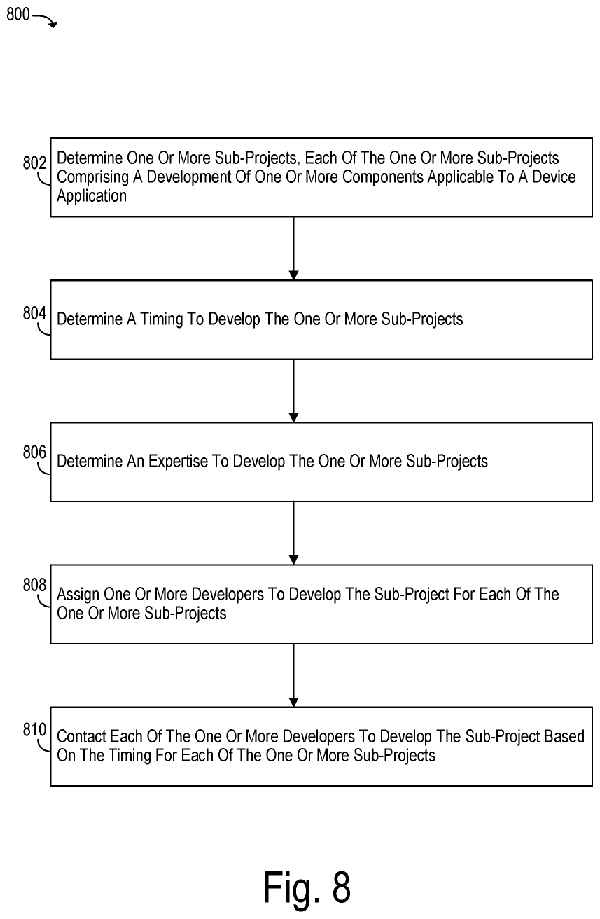

Referring to FIG. 8, FIG. 8 is a flow diagram 800 of another embodiment of the disclosed subject matter. At step 802, the system to allocate resources may determine one or more subprojects, where each of the one or more subprojects includes a development of one or more components that are applicable to a device application. For example one or more components may include a login component for a device application. In another example, the one or more components may include a database that stores user logins for a device application. In various embodiments the one or more subprojects may include checking the quality of a device application. In various embodiments the one or more subprojects may include designing a user interface for the device application. In various embodiments, the one or more subprojects may include checking the quality, designing the user interface, and developing various components such as a database for a device application.

At step 804, the system to allocate resources may determine a timing to develop the one or more subprojects. For example, the system to allocate resources may determine that the component that logs user logins for a database is dependent on a design for the user interface. Accordingly, the system may determine that the user interface should be completed in eight within a first time and that the database be completed within a second time. Further, the system may determine various times development of the various subprojects should begin.

At step 806, the system to allocate resources may determine an expertise to develop the one or more subprojects. For example, the expertise may be an area of expertise or a total development expertise or combination thereof. In various embodiments, the system may determine more than one expertise for a subproject. In one example, the system may determine that it requires a rank 2 developer in front-end development as well as a rank 2 developer in cross-platform development.

At step 808, the system to allocate resources may assign one or more developers to develop a subproject for each of the one or more subprojects. The one or more developers may be selected based on the expertise determined at step 806 and the timing determined at step 804. The system may further optimize selection of the developer based on the expertise and timing. For example, the system may allocate a developer with a high classification to perform a difficult subproject and allocate a lower ranked developer for a less difficult subproject.

At step 810, the system to allocate resources may contact each of the one or more developers to develop the subproject based on the timing for each of the one or more subprojects. In an exemplary embodiment, the one or more developers may be contacted via an automated communication that is initiated by a computing system. For example, the one or more developers may be emailed by a computing system where the email specifies the timing that is determined in step 804. In various embodiments, the computing system may communicate with the one or more developers by various other means. For example, the computing system may call the one or more developers using a bot that communicates with the one or more developers. The system to allocate resources may further refine the time to develop the one or more subprojects based on a response from the one or more developers. For example, the one or more developers may communicate a time conflict that will cause the system to allocate resources to update the timing.

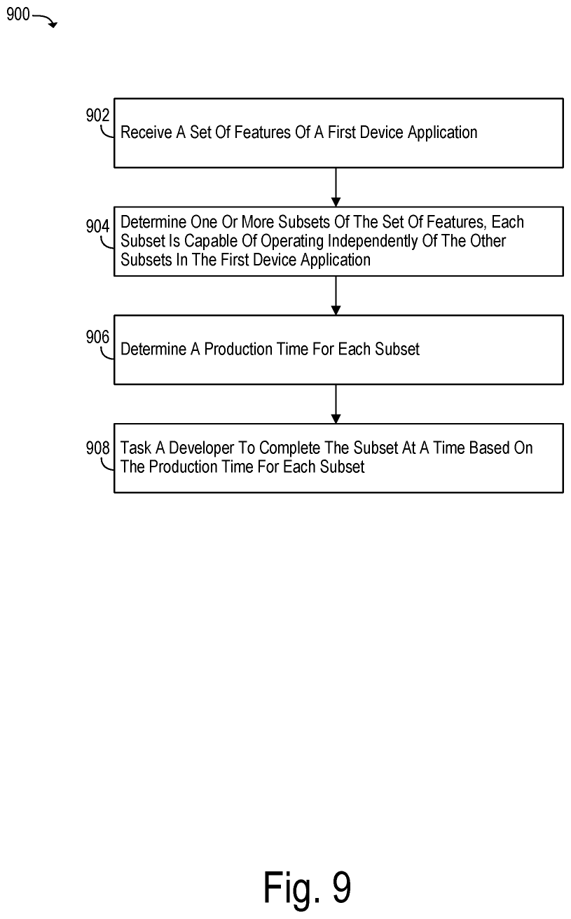

Referring to FIG. 9, FIG. 9 is a flow diagram 900 of yet another embodiment of the disclosed subject matter. At step 902, the system to allocate resources may receive a set of features of a 1^{st} device application. In various embodiments, the 1^{st} set of features may be supplied by a client user, a computer system, or developer. In an exemplary embodiment, a user may describe a device application in ordinary language. The described computing system may convert the users ordinary language into a set of features that are received in step 902.

At step 904, the system to allocate resources may determine one or more subsets of the set of features where each subset is capable of operating independently of the other subsets in the 1^{st} device application. In an exemplary embodiment, the system determines features that are dependent on one another and separates them into groups. For example, a backend for a login user interface feature may be dependent on a front-end for the login user interface feature. Accordingly, the front-end and backend of the login user interface may be grouped together in a subset of the set of features. However, a geo-mapping feature may operate independently of the login user interface and may be grouped into a separate subset from the login user interface feature.

At step 906, the system to allocate resources may determine a production time for each subset. In various embodiments, the production time may comprise a total time to complete the subset. In an exemplary embodiment, the production time further comprises a time to begin the subset. For example, the system to allocate resources may determine a beginning time for each subset such that each of the subsets are completed before a deadline.

At step 908, the system to allocate resources may task a developer to complete the subset at a time based on the production time for each subset. In an exemplary embodiment, the system may automatically contact a developer to complete the subset. The system to allocate resources may determine an optimal developer based on the feature or features in the subset. The optimal developer may be selected based on various criteria such as the area of expertise of the developer the total experience of the developer, the difficulty of the subset, and the time zone of the developer.

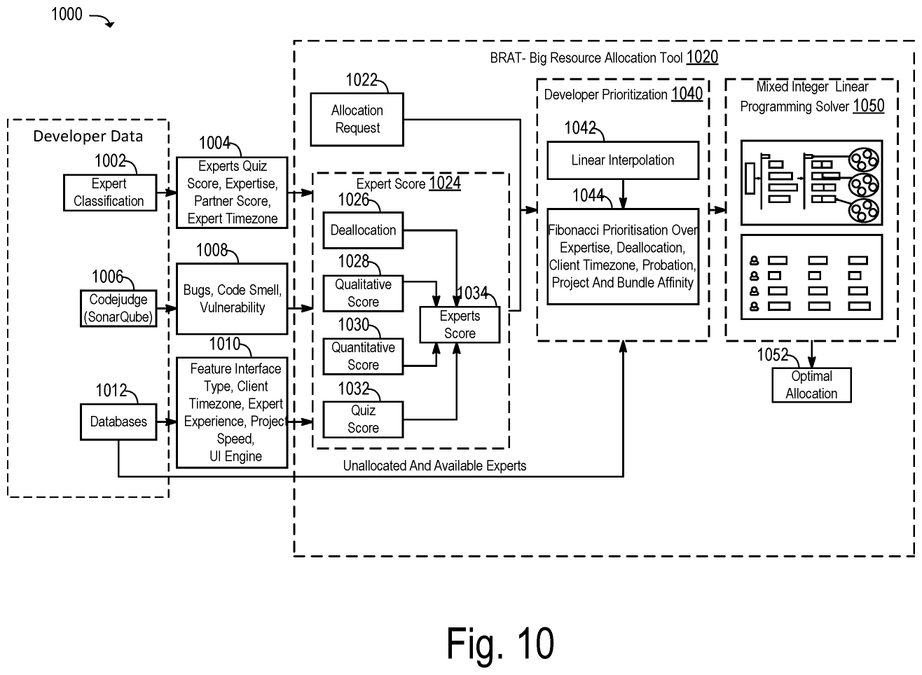

Referring to FIG. 10, FIG. 10 is a flow diagram 1000 of an embodiment of a system for allocating developers to a job. The system to allocate developers to a job may include a big resource allocation tool 1020 which is also referred herein as BRAT 122. The big resource allocation tool 1020 may accept an allocation request 1022 to perform work that can be applied to one or more device applications. To allocate one or more developers to the work, the big resource allocation tool 1020 may accept various developer data.

As shown in FIG. 10, an exemplary embodiment of the developer data may include expert classification 1002 data, automated code analysis data such as Codejudge 1006 or SonarQube data, database 1012 data, and knowledge graph data. Developer data for designer developers and quality analysis developers may vary from the developer data shown in FIG. 10. The expert classification 1002 data may include expert quiz scores, expertise of developers, partner scores for developers, and time zones in which the developer resides, which are together referred to as classification data 1004. The automated code analysis data may include various bugs 1008, code smell, and vulnerability of code for developers that write code. In an exemplary embodiment the database data 1010 may include a feature interface type, a client time zone, a developer's experience, the expected speed of the project, and a user interface engine. Examples of feature interface types included navigation interfaces, and input interface, a settings interface, and immediate interface. Examples of user interface engines include, but are not limited to React Native, Flutter, Xamarin, and Ionic.

The developer data may be used by the big resource allocation tool 1020 to determine an expert score 1024. In an exemplary embodiment, a calculated expert score 1034 is determined based on an allocation state 1026 of the developer, a qualitative score 1028 of the developer, a quantitative score 1030 of a developer, and a quiz score 1032 of a developer. The allocation state 1026 of the developer may comprise the current status of the developer. For example, if a developer is working on a job and is unavailable, the developer would be in a state of “allocated.” The qualitative score 1028 of the developer may be a score based on a quality of the developers work. For example, a developer's Codejudge 1006 analysis may be factored into the qualitative score 1028. The quantitative score 1030 may comprise the developer's experience, the total number projects that the developer worked on, the amount of time that the developer has worked with a client, the amount of time that the developer has worked on a development area, or a combination thereof. The quiz score 1032 may be a score as determined by the test evaluation system 542.

The developer prioritization component 1040 may determine the amount of time that should be taken to develop the various features of the allocation request 1022. The developer prioritization component 1040 may further determine a time to start the development of each feature. The developer prioritization component 1040 may prioritize various subprojects in the allocation request using linear interpolation 1042 followed by Fibonacci prioritization 1044. The linear interpolation 1042 may prioritize various tasks in the allocation request by determining their relative importance and value.

The Fibonacci prioritization 1044 may further prioritize tasks by differentiating tasks that have similar values in the linear interpolation. Criteria used in the Fibonacci request prioritization include expertise of the developer, allocation status of the developer, client time zone, developer time zone probation status of the developer, and project and bundle affinity of the developer. Project and bundle affinity of the developer refers to a quality of developers work for a specific client or for a specific project. Data from the developer prioritization component 1040 may be fed into a mixed integer linear programming (MILP) solver 1050 determine an optimal allocation 1052. The MILP solver 1052 may use the prioritization data for each subproject and determine a time frame for completion of each subproject. Groups of features may be separated into the various swim lanes or subprojects based on their interdependence.

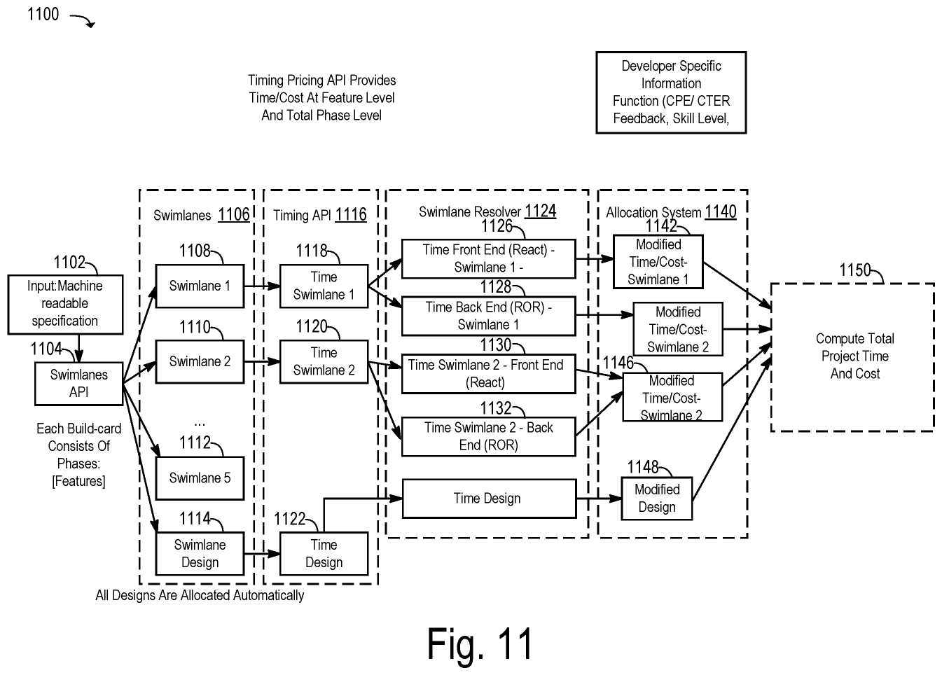

Referring to FIG. 11, FIG. 11 is a flow diagram 1100 of an embodiment for allocating developers based on a machine readable specification. As shown in the flow diagram 1100, the system for allocating resources may include a swim lanes API 1104 that resolves one or more swim lanes from a machine readable specification 1102. The term swim lane, as used herein, may refer to one or more subprojects within a project to develop a device application. Each of the subprojects or swim lanes is assumed to operate independently of the other swim lanes. The swim lanes API 1104 resolves features of the machine readable specification 1102 to determine which features operate independently of one another. The swim lanes API 1104 may further distribute work among swim lanes such that developers allocated to the various swim lanes finish at an optimized time, which may be determined by a variety of parameters.

As stated above, the swim lanes API 1104 resolves work from a machine-readable specification into multiple swim lanes 1106. In various embodiments, the swim lanes API 1104 may resolve jobs from multiple machine readable specifications 1102. As shown in the flow diagram, swim lanes may comprise a 1^{st} swim lane 1108, a 2^{nd} swim lane 1110, and an Nth swim lane 1112. Further, the swim lanes API 1104 may resolve a design swim lane 1114, which includes design work that was resolved from the machine readable specification 1102. The swim lanes of 1106 may also include, but are not shown in FIG. 11, one or more swim lanes comprising quality control jobs.

Based on the swim lanes 1106, the system to allocate resources may include a timing API 1116 that optimizes swim lanes based on a predicted time of completion for each swim lane. The timing API may determine a time of completion based on a difficulty of the job and experience of the developer. In various embodiments a machine learning algorithm may be used to predict a time for jobs the are resolved from the machine-readable specification. Training data to determine completion time for jobs resolved from the machine-readable specification may include historical data from previous jobs. As shown in the flow diagram 1100, the timing API 1116 may determine a completion time for a 1^{st} swim lane 1118, a 2^{nd} swim lane 1120, and a design swim lane 1122.

The system to allocate resources may further resolve swim lanes based on developer parameters. Accordingly, jobs within a swim lane may be optimally distributed to developers. In the example shown in the flow diagram 1100, swim lanes are divided by a swim lane resolver 1124 based on an area of expertise. The 1^{st} swim lane is divided into front-end development 1126 and backend development 1128. In an exemplary embodiment, front-end development may be coded in React Native and backend development may be coded in Ruby on Rails. Thus, jobs for swim lane 1 may be divided between developers that specialize in React Native and developers that specialize in Ruby on Rails. The system to allocate resources may determine optimal timing to allocate the jobs divided from a single swim lane as one may be dependent on the other. Accordingly, in the example shown in the flow diagram 1100, and allocation system 1140 may schedule front-end development 1126 to be completed at an earlier time 1142 than the backend development 1128.

In various embodiments, the allocation system 1140 may determine a number of developers that are needed to be allocated for each swim lane and/or each divided swim lane. In the example shown in the flow diagram 1100, the allocation system 1140 may consolidate a front-end version of the 2^{nd} swim lane 1130 and a backend version of the 2^{nd} swim lane 1132 into development by a single developer that can be allocated at a single time 1146. The allocation system 1140 may further determine a time to allocate one or more developers to complete one or more designs 1148. At step 1150, the system to allocate resources may compute a total project time and cost based on developer allocations and the difficulty of the jobs resolved from the machine readable specification 1102.

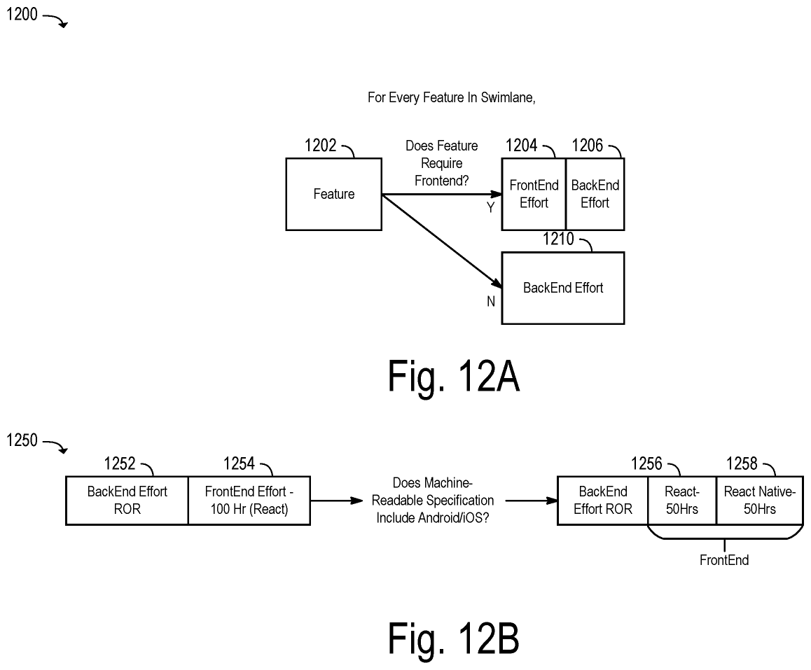

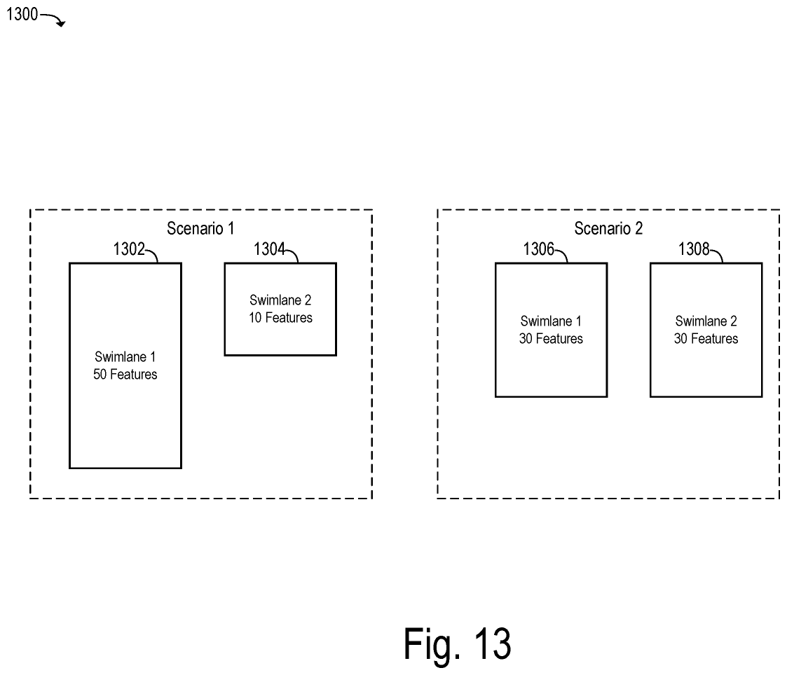

Referring to FIGS. 12A-12B, FIGS. 12A-12B are schematics of embodiments for assessing the effort required for a feature to be completed. FIG. 12A is a schematic 1200 showing how a system for allocating resources may break down a feature into multiple jobs. The swim lane resolver 1124 and allocation system 1140 combined to break a feature, swim lane, or subproject, into subparts. In various embodiments, the allocation system determines the amount of effort required to complete every feature in a swim lane. The allocation system 1140 determines one or more dependencies for every feature. For instance, the allocation system may determine whether a front-end is required for any feature. The term front-end as used herein refers to a part of a device application that is configured to accept input from a user. For instance, any part of a device application that directly interacts with a user may be considered a front-end portion of the device application. On the other hand, portions of a device application that did not accept input or interact with a user may be considered a backend. Many, but not all, backend portions of a device application are dependent on input that is accepted from the front-end.

In various embodiments, the swim lane resolver 1124 may determine various interdependencies within a feature. In the example shown in the schematic 1200, the system for allocating resources may determine whether a feature 1202 requires a front-end. If the feature 1202 does require a front-end, the effort required to complete the feature 1202 may be broken up into front-end effort 1204 and backend effort 1206. If the feature 1202 does not require a front-end, work to complete the feature may be limited to backend effort 1210. In various embodiments, jobs to produce a front-end or backend may require different expertise. For example, a developer may prefer that a front-end be coded in React Native and that a backend be coded in Ruby on Rails. Accordingly, different developers may specialize in either front-end, backend development, or both. The system for allocating resources may allocate developers based on the interdependencies for each feature and determine timing for when interdependent portions of a feature are developed. For example, the system for allocating resources may schedule a front-end to be developed for a backend.

Referring to FIG. 12B, FIG. 12B is a schematic 1250 showing how a feature may be further divided into subparts based on dependencies. As shown in the schematic 1250, a feature may be divided into a backend effort 1252 and a front-end effort 1254. If for example the machine-readable specification includes compatibility with android/iOS, the front-end may be further divided into a front-end that is encoded in React 1256 and a front-end that is coded in React Native 1258.

Referring to FIG. 13, FIG. 13 is a schematic 1300 of an exemplary embodiment for allocating resources to a job. As shown in FIG. 11, resource allocation system may establish subprojects or swim lanes based at least partly on an amount of effort required to complete a swim lane. For example 2 features that are not dependent on one another may be arbitrarily placed in any swim lane relative to one another. When the resource allocation system determines an optimal allocation of developers to complete a job with multiple swim lanes, the allocation system may generate swim lanes based on various criteria.

For example, the system for allocating resources may generate swim lanes based on the amount of effort required to complete each swim lane. As shown in scenario 1 in the schematic 1300, a 1^{st} swim lane 1302 includes 50 features and a 2^{nd} swim lane 1304 includes 10 features. The system may generate swim lane shown in scenario 1 when it determines that each of the swim lanes may require the same amount of effort. For example the effort required to complete all the features in the 2^{nd} swim lane 1304 may be the same as the effort to complete the 50 features in the 1^{st} swim lane 1302. The system for allocating resources may factor difficulty of features, a timeline needed to complete the features, and the relative speed of the developers will be allocated complete the swim lane. For example, a relatively inexperienced developer may be expected to develop at a slow speed, which may be considered in generating the swim lanes.

In an exemplary embodiment, as shown in scenario 2 system for allocating resources may distribute features equally between swim lanes. Accordingly, the 1^{st} swim lane 1306 and 2^{nd} swim lane 1308 may be generated with an equal number of 30 features. Additional embodiments may consider additional criteria for adding features to swim lanes.

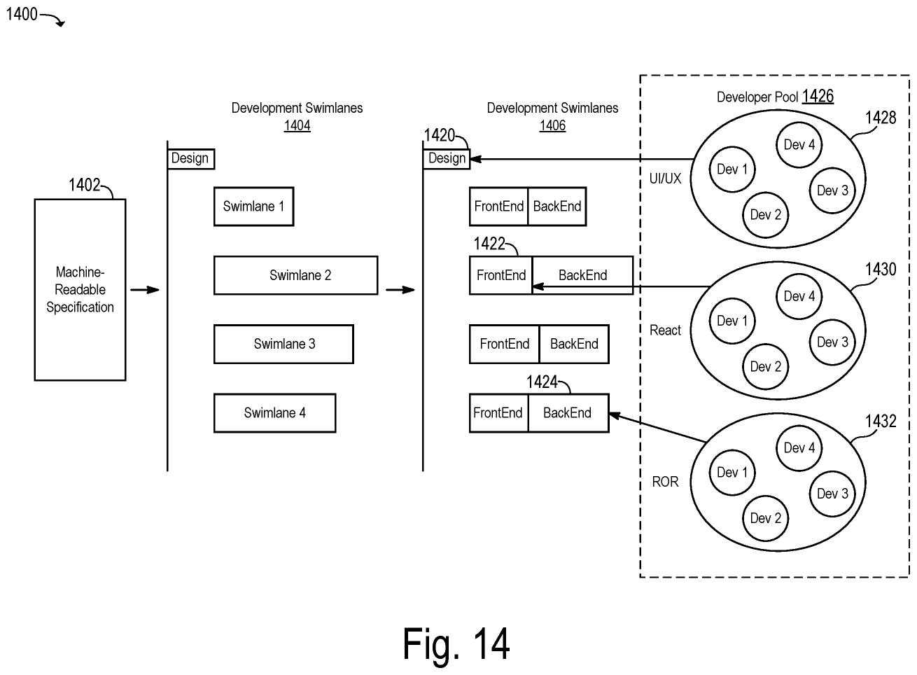

Referring to FIG. 14, FIG. 14 is another schematic 1400 of an exemplary embodiment for allocating resources to a job. As shown in FIG. 11, the system for allocating resources may convert a machine-readable specification into multiple swim lanes or subprojects that each include a predicted amount of time to complete. Accordingly, the machine-readable specification 1402 of the schematic 1400 is converted into multiple development swim lanes 1404.

And as shown in FIG. 12A, the system to allocate resources may further resolve features in each swim lane based on various criteria such as developer expertise. For instance, the development swim lanes 1406 may include swim lanes that are resolved into a front-end and a backend. The system to allocate resources may then allocate one or more developers from a developers pool 1426 to work on the resolved jobs from the development swim lanes 1406. For instance, one or more designer developers from a designer pool 1428 may be allocated to a design swim lane 1420 or design subproject. If the front-end jobs in the development swim lanes 1406 comprise coding in React, one or more developers from a development pool of React developers 1430 may be allocated to complete a front-end project from one or more of the development swim lanes.

When there are more jobs than there are developers, the system to allocate resources may use various criteria to select which job gets completed first. For example as shown in the schematic 1400, the front-end 1422 of swim lane 2, which has the highest development effort as evidenced by the horizontal length of swim lane 2, may be selected to be completed first. Other criteria may be used as well. For instance, if a backend system requires a front-end before it can be properly developed, the system to allocate resources may be forced to wait and tell a front-end is developed until backend developers can be allocated to work on a backend job. However, if one or more front-ends are already developed based on other projects or other machine-readable specifications, their associated backends can begin development immediately. For example, if swim lane 4 has a front-end that is already developed, the system to allocate resources may allocate one or more backend developers 1432 who specialize in Ruby on Rails to begin development on a backend project 1424 for swim lane 4.

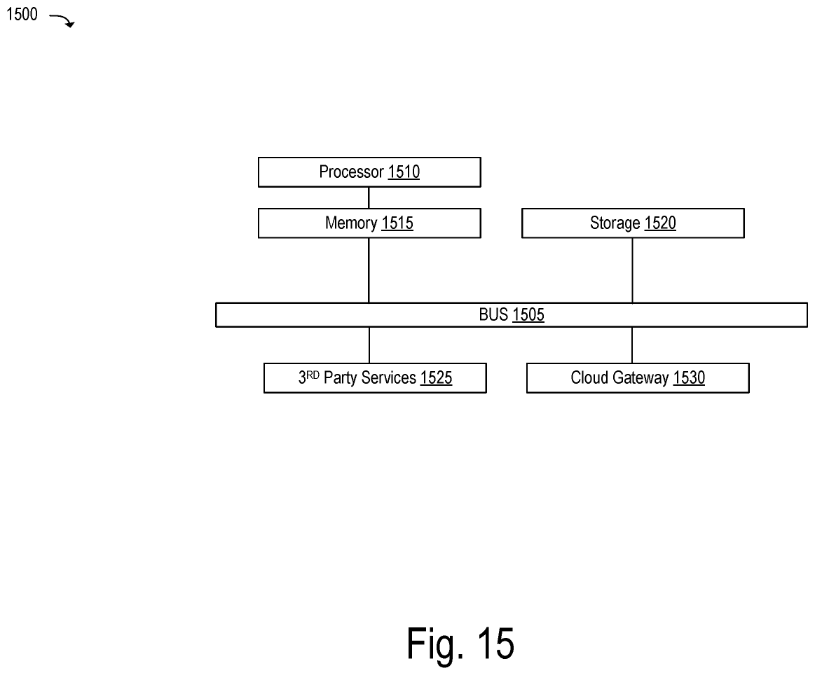

Referring to FIG. 15, FIG. 15 is a schematic illustrating a computing system 1500 that may be used to implement various features of embodiments described in the disclosed subject matter. The terms components, entities, modules, surface, and platform, when used herein, may refer to one of the many embodiments of a computing system 1500. The computing system 1500 may be a single computer, a co-located computing system, a cloud-based computing system, or the like. The computing system 1500 may be used to carry out the functions of one or more of the features, entities, and/or components of a software project.

The exemplary embodiment of the computing system 1500 shown in FIG. 15 includes a bus 1505 that connects the various components of the computing system 1500, one or more processors 1510 connected to a memory 1515, and at least one storage 1520. The processor 1510 is an electronic circuit that executes instructions that are passed to it from the memory 1515. Executed instructions are passed back from the processor 1510 to the memory 1515. The interaction between the processor 1510 and memory 1515 allow the computing system 1500 to perform computations, calculations, and various computing to run software applications.

Examples of the processor 1510 include central processing units (CPUs), graphics processing units (GPUs), field programmable gate arrays (FPGAs), complex programmable logic devices (CPLDs), and application specific integrated circuits (ASICs). The memory 1515 stores instructions that are to be passed to the processor 1510 and receives executed instructions from the processor 1510. The memory 1515 also passes and receives instructions from all other components of the computing system 1500 through the bus 1505. For example, a computer monitor may receive images from the memory 1515 for display. Examples of memory include random access memory (RAM) and read only memory (ROM). RAM has high speed memory retrieval and does not hold data after power is turned off. ROM is typically slower than RAM and does not lose data when power is turned off.

The storage 1520 is intended for long term data storage. Data in the software project such as computer readable specifications, code, designs, and the like may be saved in a storage 1520. The storage 1520 may be stored at any location including in the cloud. Various types of storage include spinning magnetic drives and solid-state storage drives.

The computing system 1500 may connect to other computing systems in the performance of a software project. For instance, the computing system 1500 may send and receive data from 3^{rd} party services such as Office 365 and Adobe. Similarly, users may access the computing system 1500 via a cloud gateway 1530. For instance, a user on a separate computing system may connect to the computing system 1500 to access data, interact with the run entities 108, and even use 3^{rd} party services 1525 via the cloud gateway.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for developing device applications, the method comprising:
receiving a set of features of a first device application;
determining one or more subsets of the set of features, each subset is capable of operating independently of other subsets in the first device application;
determining a production time for each subset; and
for each subset, tasking a developer to complete the subset at a time based on the production time.

2. The method of claim 1, further comprising determining internal dependencies for each subset; and
wherein the production time is determined based on the internal dependencies.

3. The method of claim 1, further comprising determining a difficulty of developing each feature of the set of features; and
wherein tasking the developer comprises correlating an expertise of the developer to the difficulty.

4. The method of claim 3, wherein the expertise of the developer is determined by an automated evaluation, the automated evaluation comprising:
determining a score for the developer;
assigning, to the developer, a job based on a machine readable specification, the machine readable specification comprising one or more jobs that are completable by the developer; and
receiving a completed job based on one of the one or more jobs; and
updating the score based on an assessment of the completed job.

5. The method of claim 4, wherein the score is a classification that corresponds to a classification of the job.

6. The method of claim 5, further comprising determining the classification of the job based on the machine readable specification.

7. The method of claim 1, wherein tasking the developer comprises automatically contacting, by a computer system, the developer to communicate a job to complete the subset.

8. A computer system configured to develop a device application, the computer system comprising:
a processor coupled to a memory, the processor configured to:
receive a set of features of a first device application;
determine one or more subsets of the set of features, each subset is capable of operating independently of other subsets in the first device application;
determine a production time for each subset; and
for each subset, task a developer to complete the subset at a time based on the production time.

9. The computer system of claim 8, wherein the processor is further configured to determining internal dependencies for each subset; and
wherein the production time is determined based on the internal dependencies.

10. The computer system of claim 8, wherein the processor is further configured to determine a difficulty of developing each feature of the set of features; and
wherein task a developer comprises the processor configured to correlate an expertise of the developer to the difficulty.

11. The computer system of claim 10, wherein the expertise of the developer is determined by an automated evaluation, the automated evaluation comprising the processor further configured to:
determine a score for the developer;
assign, to the developer, a job based on a machine readable specification, the machine readable specification comprising one or more jobs that are completable by the developer; and
receive a completed job based on one of the one or more jobs; and
update the score based on an assessment of the completed job.

12. The computer system of claim 11, wherein the score is a classification that corresponds to a classification of the job.

13. The computer system of claim 12, wherein the processor is further configured to determine the classification of the job based on the machine readable specification.

14. The computer system of claim 8, wherein task the developer comprises the processor being configured to automatically contact the developer to communicate a job to complete the subset.

15. A computer readable storage medium having data stored therein representing software executable by a computer, the software comprising instructions that, when executed, cause the computer readable storage medium to perform:
receiving a set of features of a first device application;
determining one or more subsets of the set of features, each subset is capable of operating independently of other subsets in the first device application;
determining a production time for each subset; and
for each subset, tasking a developer to complete the subset at a time based on the production time.

16. The computer readable storage medium of claim 15, wherein the instructions further cause of the computer readable storage medium to perform determining internal dependencies for each subset; and
wherein the production time is determined based on the internal dependencies.

17. The computer readable storage medium of claim 15, wherein the instructions further cause of the computer readable storage medium to perform determining a difficulty of developing each feature of the set of features; and
wherein tasking the developer comprises correlating an expertise of the developer to the difficulty.

18. The computer readable storage medium of claim 17, wherein the instructions further cause of the computer readable storage medium to perform determining a difficulty of developing each feature of the set of features; and
wherein tasking the developer comprises correlating an expertise of the developer to the difficulty.

19. The computer readable storage medium of claim 18, wherein the instructions further cause of the computer readable storage medium to perform:
determining a score for the developer;
assigning, to the developer, a job based on a machine readable specification, the machine readable specification comprising one or more jobs that are completable by the developer; and
receiving a completed job based on one of the one or more jobs; and
updating the score based on an assessment of the completed job.

20. The computer readable storage medium of claim 19, wherein the score is a classification that corresponds to a classification of the job.
